(19) United States
(12) Patent Application Publication
(10) Pub. No.: US 2010/0072013 A1
(43) Pub. Date: Mar. 25, 2010

(54) CORD REEL ELECTRIC CORD WITH PLUG FOR HANDHELD APPLIANCE

(75) Inventor: VITO JAMES CARLUCCI, STRATFORD, CT (US)

Correspondence Address: Lawrence Cruz;Conair Corporation, One Cummings Point Road, STAMFORD, CT, 06902, US

(73) Assignee: CONAIR CORPORATION, STAMFORD, CT (US)

(21) Appl. No.: 12/270,264

(22) Filed: Nov. 13, 2008

Related U.S. Application Data
(60) Provisional application No. 60/987,937, filed on Nov. 14, 2007.

(51) Int. Cl. H02G 11/02; H01R 39/00; B65H 75/44; B65H 75/38; B65H 75/40

(52) U.S. Cl. 191/12.4; 439/4; 242/396.1

(57) ABSTRACT

A retractable electrical cord reel for an appliance wherein the cord reel is not internally-housed within the appliance. The retractable cord reel comprises reel housing, electrical plug, electrical cord, a spool assembly, which includes a spring, for winding and unwinding the electrical cord, a latching system, and contact rings or shafts to electrically connect the plug to the electrical cord. The contact rings are connected to floating contacts, which are in turn connected to the electrical plug. The contact rings are further connected to the electrical cord, thus connecting the electrical plug to the electrical cord.

### CROSS-REFERENCE TO RELATED APPLICATIONS

This application claims priority to U.S. Provisional Application No. 60/987,937 filed Nov. 14, 2007, entitled “CORD REEL ELECTRIC CORD WITH PLUG FOR HANDHELD APPLIANCE,” Vito James Carlucci, inventor, which application is incorporated herein by reference for all purposes as though fully set forth herein.

### BACKGROUND OF THE INVENTION

The present invention relates to electric handheld appliances and, more particularly, to handheld appliances requiring an electrical power cord.

Various known handheld electronic appliances have electric cords that deliver electrical energy to the appliance from an external power source. The cords are typically permanently attached or, sometimes, detachable through a plug type connection. Certain handheld appliances are used in environments where cords are cumbersome. For example, typical home users of hair curling irons use the irons at a vanity countertop that has other items already located on the countertop. The cord may inadvertently contact and get caught on or knock over these items. Also, a user must leave the curling iron out to cool off before storing it away in a container or a drawer, leaving the cord as an obstruction. Some appliances, such as vacuum cleaners, and some handheld appliances, such as hair dryers, have internally-housed cord reels for non-detachable electrical cords take up space and add weight and size to the appliance.

There is a need, therefore, for a means of overcoming the above-described shortcomings of corded electric appliances.

It is an object of the present invention to provide an electrical cord reel for an appliance, wherein the cord reel is not internally-housed in the appliance.

It is a further object of the present invention to provide an electrical cord reel on an appliance that minimizes space during and after use, while not adversely affecting performance.

These and other objects are achieved by the present invention. Further objects and advantages of the invention will be apparent from the following description of the invention.

### SUMMARY OF THE INVENTION

The present invention is directed to a retractable electrical cord reel for an appliance wherein the cord reel is not internally-housed within the appliance. The retractable cord reel comprises reel housing, electrical plug, electrical cord, a spool assembly, which includes a spring, for winding and unwinding the electrical cord, a latching system, and contact rings or shafts to electrically connect the plug to the electrical cord.

In one embodiment, the contact rings are mounted on a front of a spool assembly. The contact rings are connected to floating contacts, which are in turn connected to the electrical plug. The contact rings are further connected to the electrical cord, thus connecting the electrical plug to the electrical cord.

In another embodiment, the electrical plug is connected to contact shafts, which are in turn connected to ring contacts. Because the ring contacts are connected to the electrical cord, the electrical cord thus remains always connected to the electrical plug.

In another embodiment, the electrical cord is provided with a plug-in power jack for use with an appliance that is adapted to receive a plug-in power jack. In such an embodiment, the electrical cord is detachable from the appliance. In another embodiment, the electrical cord is permanently attached, i.e., not detachable, from the appliance.

In another embodiment, the electrical plug can fold into the reel housing.

A feature of the present invention is that the cord reel can be plugged into an electrical socket.

Another feature of the present invention is that the cord reel can be small, compact, and/or light in weight.

Yet another feature of the present invention is that the electrical cord is extendable from the reel housing while the electrical plug is plugged into a power source or an electric socket.

Other and further features, advantages, and benefits of the invention will become apparent in the following description taken in conjunction with the following drawings.

It is to be understood that the foregoing general description and the following detailed description are exemplary and explanatory but are not to be restrictive of the invention. The accompanying drawings, which are incorporated in and constitute a part of this invention, illustrate embodiments of the invention and, together with the description, serve to explain the principles of the invention in general terms. Like numerals refer to like parts throughout the disclosure.

### BRIEF DESCRIPTION OF THE DRAWINGS

The foregoing aspects and other features of the present invention are explained in the following description, taken in connection with the accompanying drawings, wherein:

FIG. 1 is a perspective view of an embodiment of the present invention;

FIG. 2A is a perspective view of an embodiment of the present invention;

FIG. 2B is a front view of the embodiment depicted in FIG. 2A;

FIG. 2C is a top view of FIG. 2B;

FIG. 2D is a right side view of FIG. 2B;

FIG. 2E is a right side view of FIG. 2D;

FIG. 3 is a partially exploded view of an embodiment of the present invention;

FIG. 4 is an exploded view of FIG. 3;

FIG. 5 is an exploded view showing an opposite side of the view depicted in FIG. 4;

FIG. 6A is a perspective view of an embodiment of the present invention;

FIG. 6B depicts cross section A-A of FIG. 6A;

FIG. 7 is a perspective view of an embodiment of the present invention;

FIG. 8A is a perspective view of an embodiment of the present invention;

FIG. 8B is a front view of the embodiment depicted in FIG. 8A;

FIG. 8C is a left side view of FIG. 8B;

FIG. 8D is a top view of FIG. 8C;

FIG. 9 is a partially exploded view of an embodiment of the present invention;

FIG. 10 is an exploded view of the embodiment depicted in FIG. 9;

FIG. 11 is an exploded view showing an opposite side of the view depicted in FIG. 10;

FIG. 12A is a perspective view of an embodiment of the present invention; and

FIG. 12B depicts cross section A-A of FIG. 12A.

### DETAILED DESCRIPTION OF THE INVENTION

Reference will now be made in detail to embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, left, and right may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

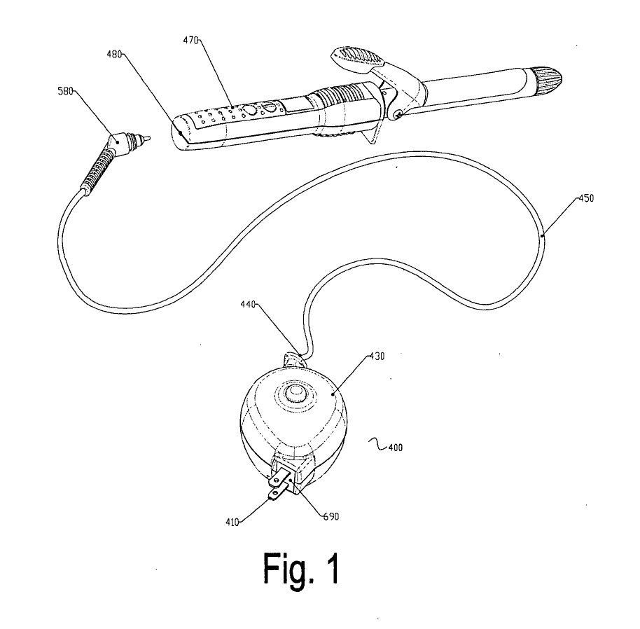

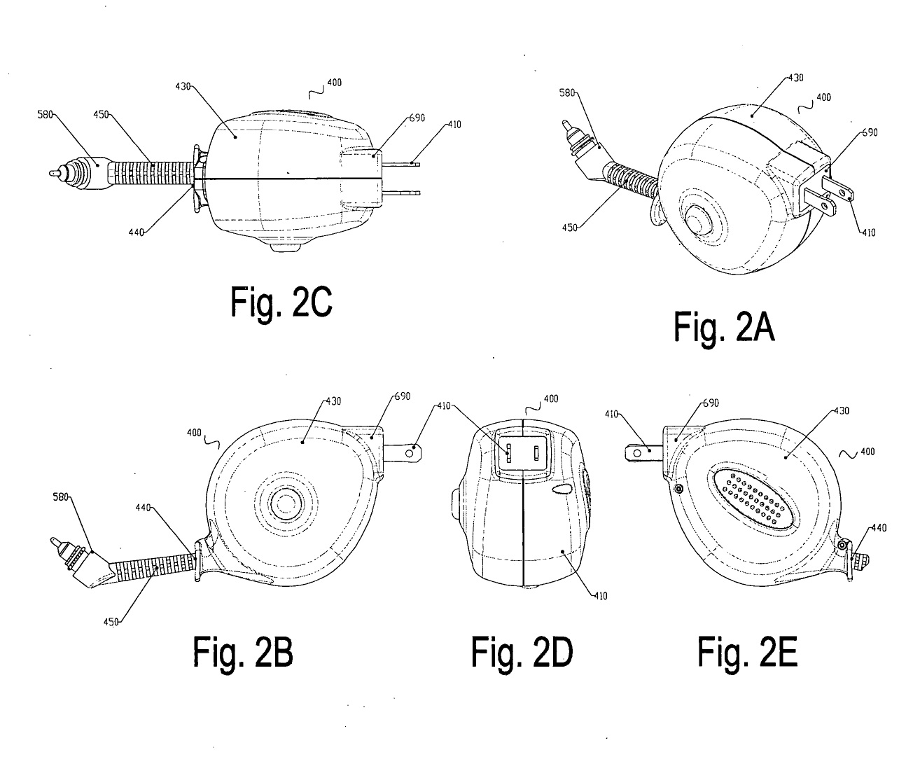

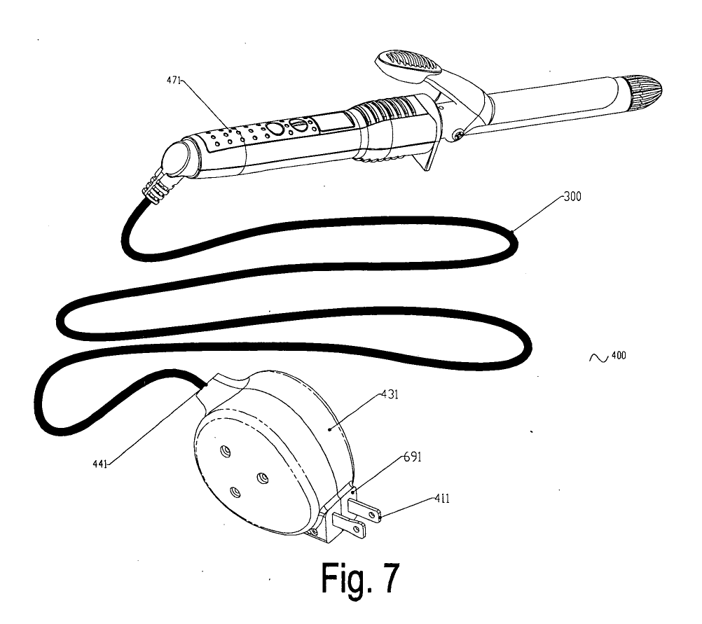

Referring to the drawings, FIGS. 1 and 2A-2E, in particular, there is shown an electrical cord reel 400 according to the present invention comprising a standard two-pronged plug 410 extending from a plug housing 420. The two-pronged plug 410 may be of any configuration and is not limited to a two-pronged plug. The plug housing 690 is attached to or within a reel housing 430. The reel housing 430 has a cord opening 440 from which an electrical cord 450 extends. The plug 410 can be folded or flipped into the reel housing 430 (not shown). The cord 450 is attachable to an appliance 470 via a plug-in jack 580 through an electrical receptacle 480 of appliance 470 which, as shown in this embodiment, is a curling iron. The cord 450 may be attached to the appliance 470 detachably, as shown in the embodiment depicted in FIG. 1, or permanently, as shown in FIG. 7. Cord reel 400 is not, however, limited to use with only curling irons and it may be used with a wide variety of electric appliances, including without limitation hair trimmers, hair clippers, and straightening irons.

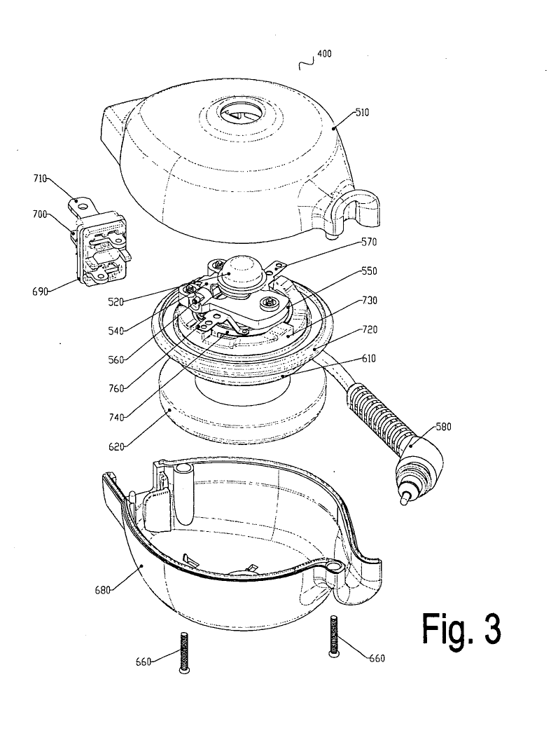

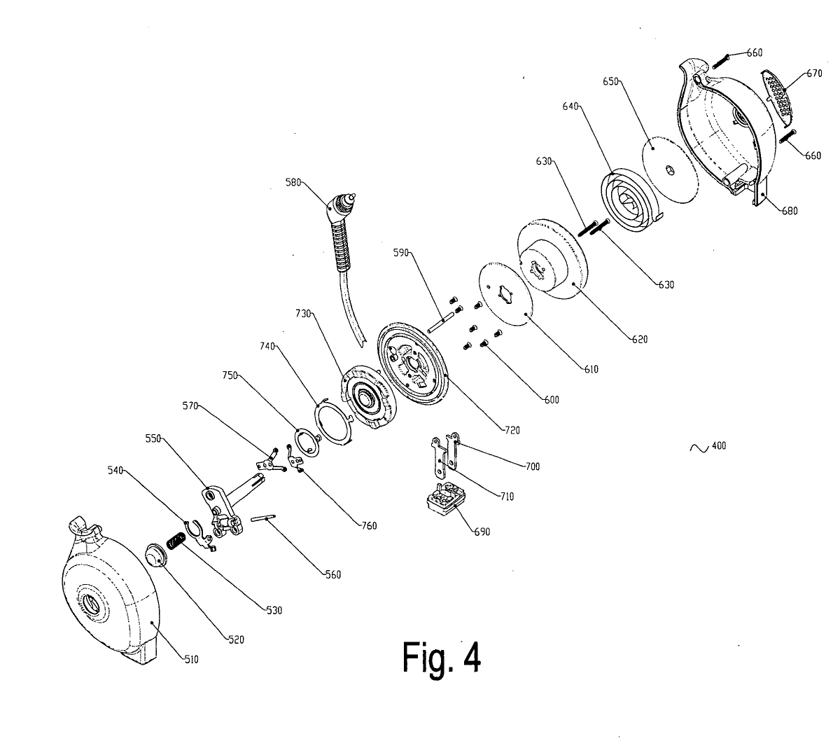

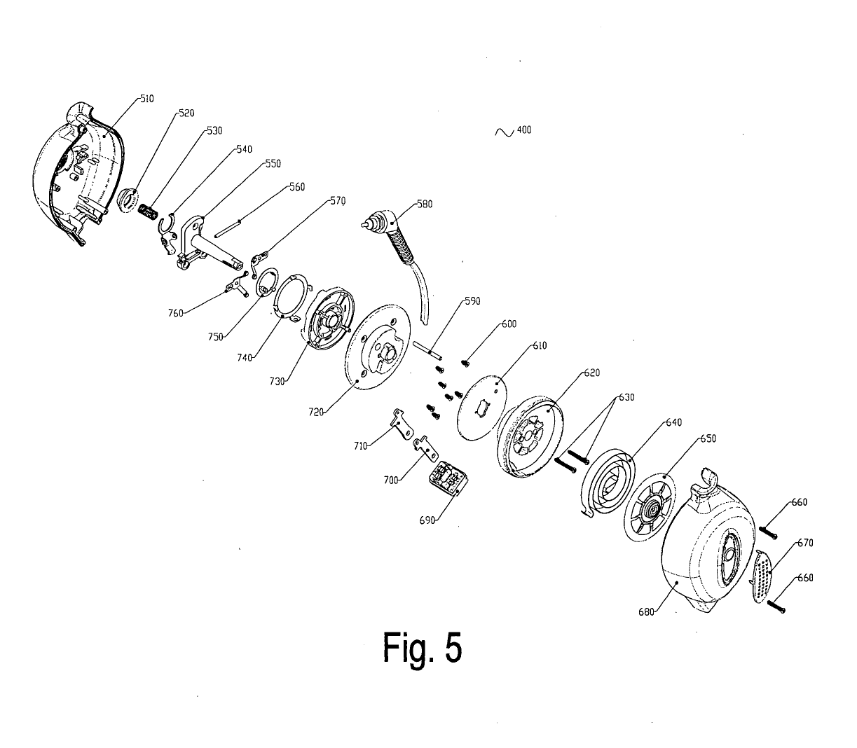

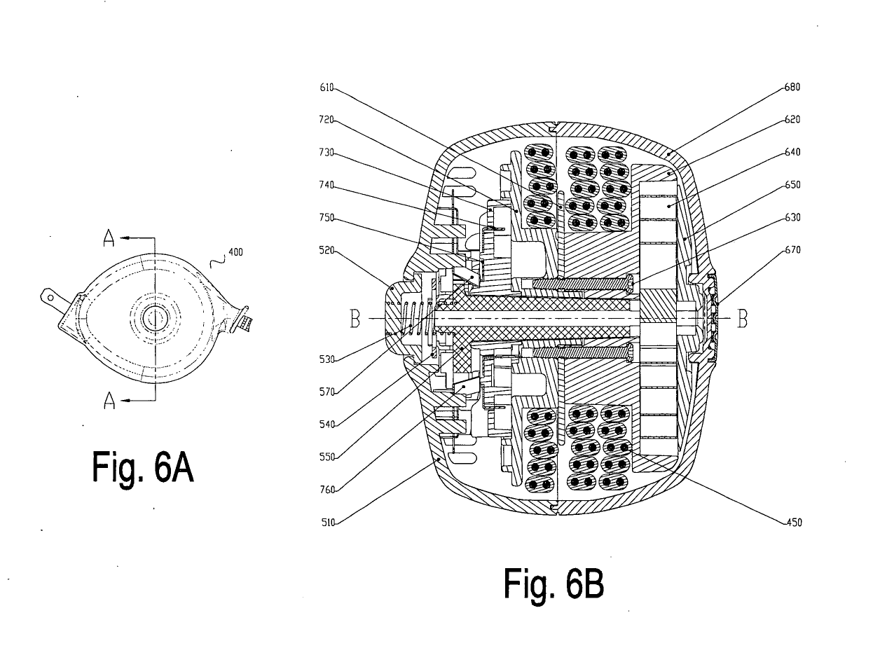

Reel housing 430 comprises left housing 510 and right housing 680. As shown in FIGS. 3-6B, within reel housing 430, a spool assembly is mounted to be rotatable around an axis B-B. The spool assembly comprises spool axle 550, spool front 720, spool pin 590, spool cord guide 610, spool back 620, spool spring 640, and spool spring cover 650. The spool spring 640 is housed on one of the spool back 620 as shown in the drawings. The spool spring 640 is wound and unwound with rotation of the spool assembly, as is generally known, to rotate and wind up the electrical cord 450.

A latching system, of a type generally known, including spool axle 550, release button 520, release spring 530, lever pin 560, and lever 540, allows locking of the cord 450 in an extended position, and automatic winding of the cord 450 when the latching system is released. A notch at a tip of spool axle 550 communicates with an inner end of the spool spring 640 such that an unwinding of the cord 450 causes the tension in the spool spring 640 to increase. The position of the spool assembly is maintained by lever 540 pressing against one of several raised patches on a surface of contact rings mount 730. Pressing release button 520 causes lever 540 to disengage from the one of several raised patches on contact rings mount 730 and the tension in spool spring 640 winds up the electrical cord 450.

Outer contact ring 740, inner contact ring 750, outer floating contact 760, and inner floating contact 570 permit electrical connection between the cord 450 and the plug 410. Outer contact ring 740 and inner contact ring 750 are mounted on the contact rings mount 730, which in turn is mounted on a side of the spool front 720. Two-pronged plug 410, as known, comprises wide plug blade 710 and narrow plug blade 700, both of which extend from plug housing 690. Plug 410 is in electrical communication, such as, e.g., by electrical wires (not shown), with outer floating contact 760 and inner floating contact 570, which, when cord reel 400 is fully assembled, are in contact respectively with outer contact ring 740 and inner contact ring 750. Outer contact ring 740 and inner contact ring 750 are in turn electrically connected to electrical cord 450 (not shown).

As shown in FIGS. 1-6B, the various components of cord reel 400 described above may be assembled using, for example, assembly screws 600, spool screws 630, and/or housing screws 660 and may even include decorative plate 670.

In use, a user plugs the cord reel 400 into an electric socket and may begin with the cord reel 400 attached or detached from the appliance 470 if the cord 300 is designed to be selectively attached and detached. FIG. 1 shows an embodiment where cord reel 400 may be detached from appliance 470. In such an embodiment, cord 450 may be terminated with, for example, plug-in jack 580. Alternatively, cord reel 400 may be permanently attached, such as shown in FIG. 7, to an appliance 471. Appliance 470 may be operated once the plug 410 is plugged into an electric socket or external power source. While the plug 410 is plugged into the wall, the spring 640 inside the reel housing 430 causes enough tension to recoil slack in the cord 450, while permitting the user to pull the appliance 470 away from the housing 430 causing the cord 450 to further extend. To retract the cord, the user simply activates release button 520 thus releasing the spool assembly from lever 540 and allowing the tension of spring 640 to retract the cord 450.

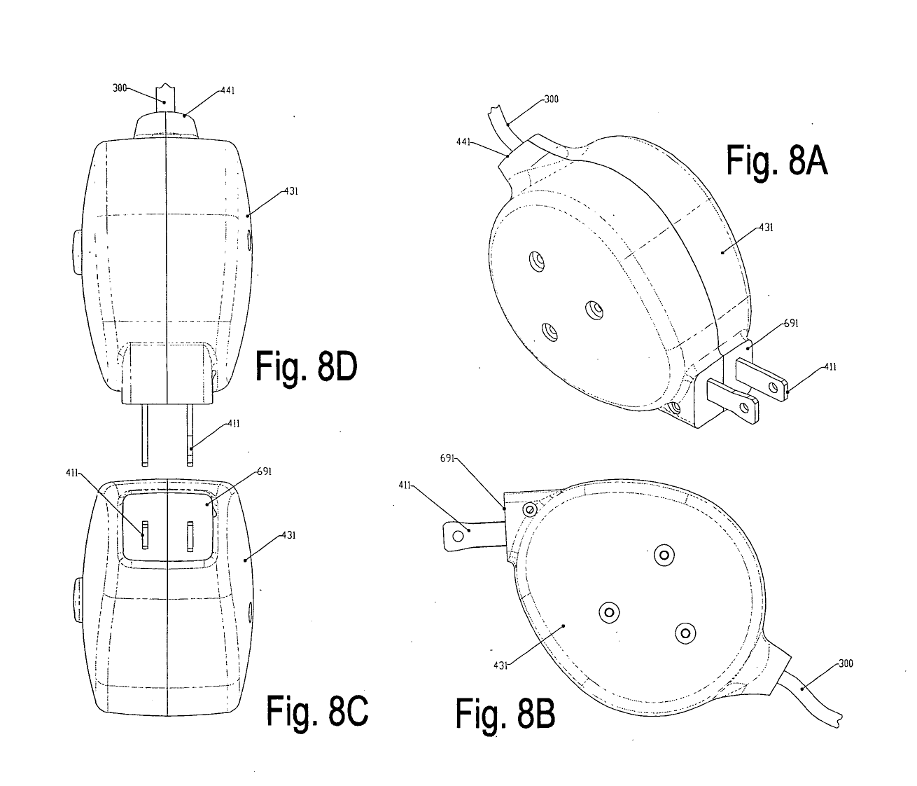

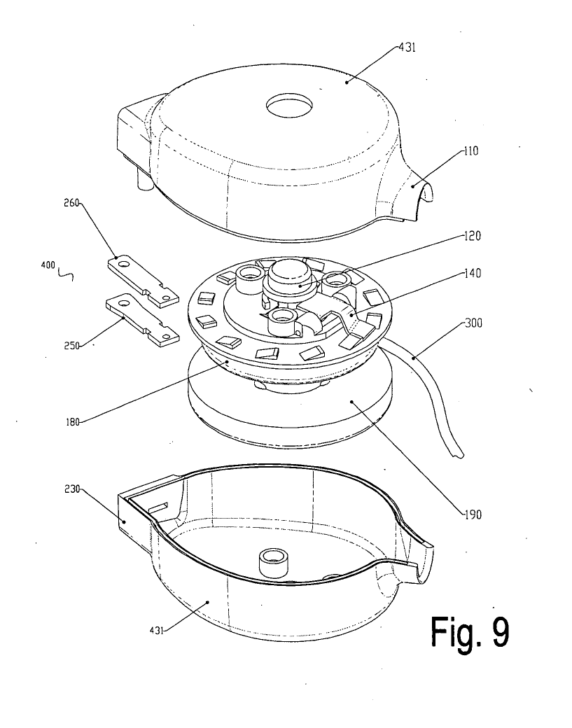

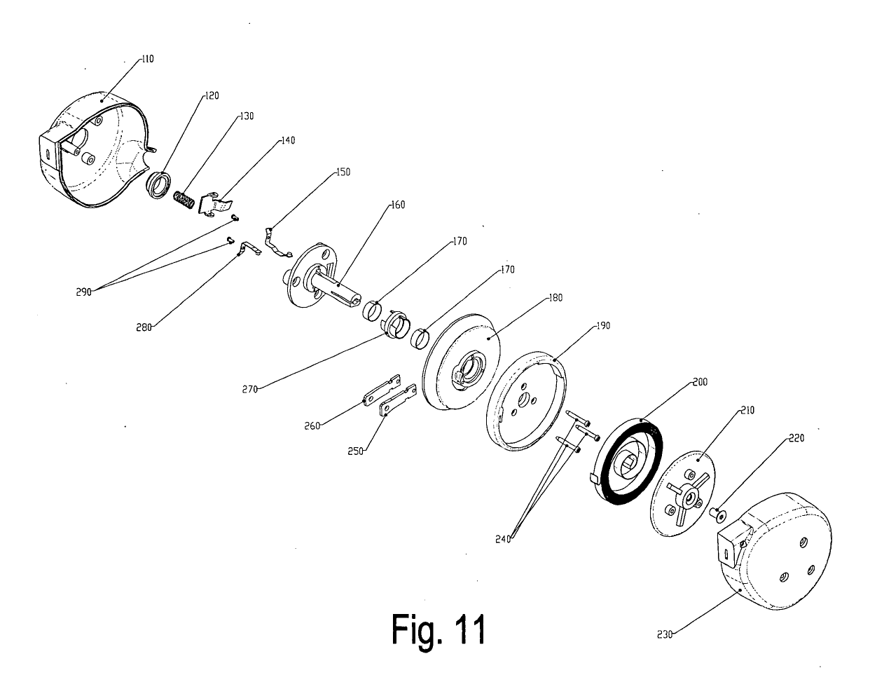

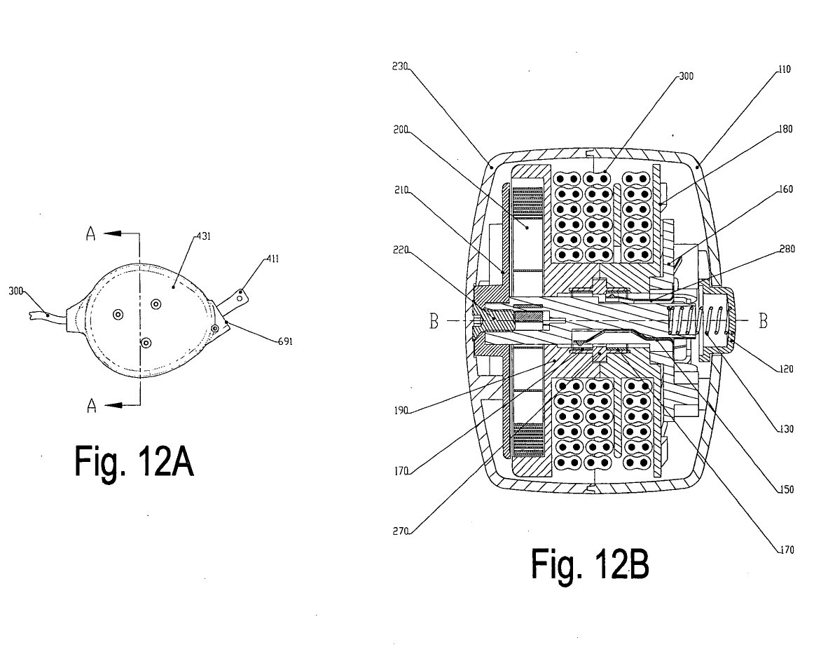

Referring to FIGS. 7-12B, there is shown another embodiment of the present invention. Electrical cord reel 400 comprises a standard two-pronged plug 411 extending from a plug housing 691. The plug 411 may be of any configuration and is not limited to a two-pronged plug. The plug housing 691 is attached to a reel housing 431. The reel housing 431 has a cord opening 441 from which an electrical cord 300 extends. As known, the plug 411 can be folded into the reel housing 431. The cord 300 is permanently attached to an appliance 471 which, as shown in this embodiment, is a curling iron.

FIGS. 7-12B show that, within reel housing 431, spool 180 is mounted to be rotatable around axis B-B. Spring 200 is wound and unwound with rotation of the spool 180, as is generally known and generally described above, to rotate and wind up the electrical cord 300. A latching system including ratchet mechanism 160 and release button 120 and spring 130, of a type generally known, allows selective locking of the cord 300 in an extended position, and automatic winding of the cord 300 when released. Ring contacts 170, long contact shaft 150, and short contact shaft 280 permit electrical connection between the cord 300 and the plug 411.

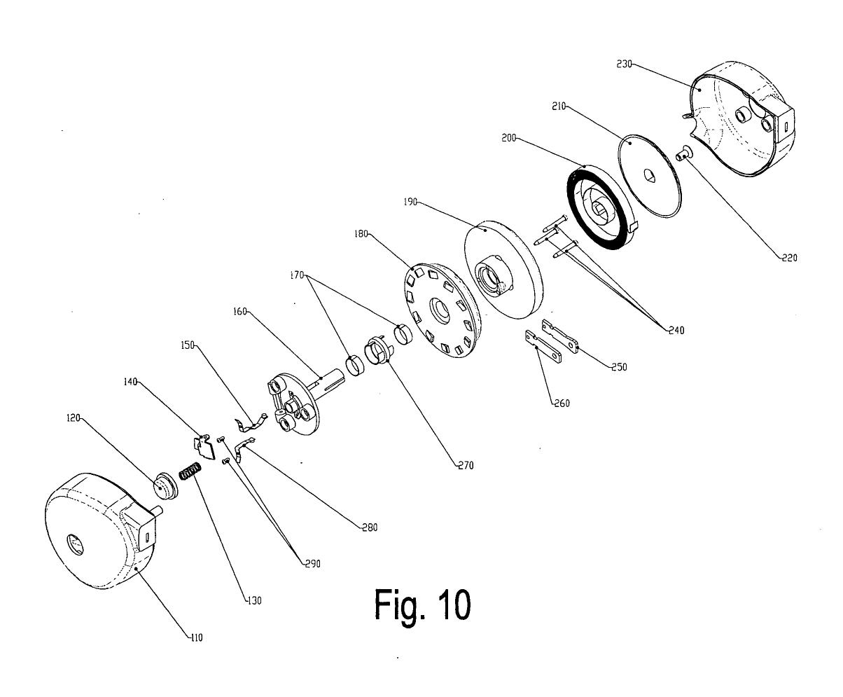

Reel housing 431 comprises left housing 110 and right housing 230. Two-pronged plug 411, as known, comprises wide plug blade 250 and narrow plug blade 260, both of which extend from plug housing 691. Plug 411 is in electrical communication, such as, e.g., by electrical wires (not shown), with contacts 170 via long contact shaft 150 and short contact shaft 280. Contacts 170 are held in place via ring contacts holder 270, which electrically isolate contacts 170 from each other. Spool 180 is affixed to spool back 190 via spool screws 240. Spring 200 is affixed to spring cover 210 via spring screw 220. Latch 140 is in communication with spool 180 as well as with release button 120 and button spring 130. So long as release button 120 is not activated, latch 140 allows spool 180 to maintain its position, as known in the art, by means of raised patches along a circumference on a surface of spool 180 (see FIG. 10).

In use, a user may begin with the cord reel 400 attached or detached from the appliance 471 if the cord 300 is designed to be selectively attached and detached. Alternatively, it may be permanently attached to the appliance 471. Once the plug 411 is plugged into the wall socket or external power source, the appliance 471 may be operated. While the plug 411 is plugged into the wall, the spring 200 inside the reel housing 431 causes enough tension to recoil slack in the cord 300, while permitting the user to pull the appliance 471 away from the housing 431 causing the cord 300 to easily further extend. To retract the cord, the user simply activates release button 120 thus releasing spool 180 from latch 140 and allowing the tension of spring 130 to retract the cord.

An important feature of the present invention is that the cord reel can be plugged into an electrical socket, unlike some prior art cord reels that wind from the center of the cord or from the appliance.

Another feature of the present invention is that the cord reel is small, compact and/or light and thus the cord reel can help reduce clutter and can be portable.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A cord reel for use with an appliance, the cord reel comprising
reel housing;
electrical plug;
electrical cord;
spool assembly;
latching system; and
release system,
wherein the reel housing is not within the appliance.

2. The cord reel of claim 1, wherein the electrical cord comprises a plug-in jack.

3. The cord reel of claim 1, wherein the electrical cord is permanently attached to the appliance.

4. The cord reel of claim 1, wherein the release system comprises a release button, a release spring, a lever pin, and a lever.

5. The cord reel of claim 1, wherein the release system comprises a release button, a release spring, and a latch.

6. The cord reel of claim 1 wherein the latching system comprises a spool axle, a lever pin, a lever, and raised patches that latch the lever into position.

7. The cord reel of claim 1 further comprising contact rings and floating contacts,
wherein the contact rings are connected to the floating contacts,
wherein the floating contacts are connected to the electrical plug, and
wherein the contact rings are connected to the electrical cord.

8. The cord reel of claim 1 further comprising contacts and contact shafts,
wherein the contacts are connected to the contact shafts,
wherein the contact shafts are connected to the electrical cord, and
wherein the contacts are connected to the electrical cord.

9. The cord reel of claim 1, wherein the electrical plug is foldable into the reel housing.

10. The cord reel of claim 1, wherein the electrical plug is two-pronged.

11. The cord reel of claim 1, wherein the electrical plug is three-pronged.

12. The cord reel of claim 1, wherein the electrical cord is extendable from the reel housing while the electrical plug is plugged into an electric socket.
